(19) United States
(12) Patent Application Publication
(10) Pub. No.: US 2006/0247945 A1
(43) Pub. Date: Nov. 2, 2006

(54) System and method for integrating disparate systems within a network

(76) Inventor: Todd F. Cummings, Farfield, CT (US)

Correspondence Address: SOFER & HAROUN, L.L.P.;Suite 910, 317 Madison Avenue, New York, NY, 10017, US

(21) Appl. No.: 11/329,373

(22) Filed: Jan. 10, 2006

Related U.S. Application Data
(60) Provisional application No. 60/643,041, filed on Jan. 11, 2005.

(51) Int. Cl. G06Q 99/00

(52) U.S. Cl. 705/1

(57) ABSTRACT

A method is provided for performing system integrations between at least first and second systems including operating an integration operation on only a third system with no adapters installed on the first and second systems. The integration operation includes generating a plurality of integration processes, each process configured to perform one or more integration functions, integrating an element of a first system with an element of a second system. The integration processes are organized into a queue with at least one queue assigned to the integration processes. Isolating each integration process from one another, such that failure of a first integration process among the plurality of integration processes does not result in the failure of any other integration process.

### RELATED APPLICATION

This application is related to and claims the benefit of priority from U.S. Provisional Patent Application No. 60/643,041, filed on Jan. 11, 2005, the entirety of which is incorporated herein by reference.

### FIELD OF THE INVENTION

The present invention (referred to throughout as Enterprise Integration Suite (EIS)) is directed to a system and method for providing a flexible, robust and cost effective way to integrate disparate systems and orchestrate processes across an entire enterprise and between business partners.

### BACKGROUND OF THE INVENTION

Today, Enterprise Application Integration (EAI) is extremely expensive and difficult. According to the Gartner Group, integration-related projects will, for the foreseeable future, continue to command the largest share of an IT department's budget. To understand why the current state of EAI is so abhorrent, the IT decision maker must understand the motivations behind integration software design and how expensive support services are baked into implementations in an effort to generate a continuous stream of revenue for the vendor. Several current leading integrators today have integration software and services strategies that exploit the two most common elements of EAI today.
Inflexibility
Complexity

High costs and vendor dependence are the ramifications of software that is inflexible and unnecessarily complex. This obviously works to the vendor's advantage, but it can end up crippling an IT department's ability to be agile and responsive to the application development needs of the organization.

Many so-called “open” integration software providers tout propriety as the culprit of ever escalating development and maintenance costs. However, when propriety is combined with system complexity may become an operational liability. Complexity leaves the user dependent on the specialized knowledge that often is only known by the vendor and a small pool of highly paid consultants.

### OBJECTS AND SUMMARY OF THE INVENTION

The present invention looks to overcome the drawbacks associated with the prior art Enterprise Application Integration and provides an EIS that allows flexibility and, at the same time, reduced complexity.

To this end, the present invention provides a method for performing system integrations between at least first and second systems. The method includes the steps of operating an integration process on only a third system with no adapters installed on the first and second systems.

The integration operation includes generating a plurality of integration processes, each process configured to perform one or more integration functions, integrating an element of a first system with an element of a second system. The integration processes are organized into a queue, with at least one queue assigned to the integration processes. Each integration process is isolated from one another, such that failure of a first integration process among the plurality of integration processes does not result in the failure of any other integration process.

### BRIEF DESCRIPTION OF THE DRAWINGS

The preferred embodiment of the invention will be explained in further detail and in reference to the drawings, in which:

FIG. 1 is a diagram of an exemplary integration server running the EIS system in accordance with one embodiment of the present invention;

FIG. 2 is a diagram of an enterprise reporting system including an exemplary integration server running the EIS system according to one embodiment of the present invention;

FIG. 3 is a prior art diagram of a database transformation arrangement;

FIG. 4 is a diagram of a database transformation arrangement including an exemplary server running the EIS system according to one embodiment of the present invention;

FIG. 5 is a screen shot of the Radar UI illustrating the relationship between a file queue and an associated managed process according to one embodiment of the present invention;

FIG. 6 is an abstract diagram illustrating Radar, the queues and processes that it manages and their relationship to the EIS in accordance with one embodiment of the present invention; and

FIG. 7 is a block diagram of the internal modules of the EIS system in accordance with one embodiment of the present invention.

### DESCRIPTION OF THE INVENTION

The present invention relates to an enterprise integration suite for managing Enterprise Application Integration (EAI) and for performing other similar tasks.

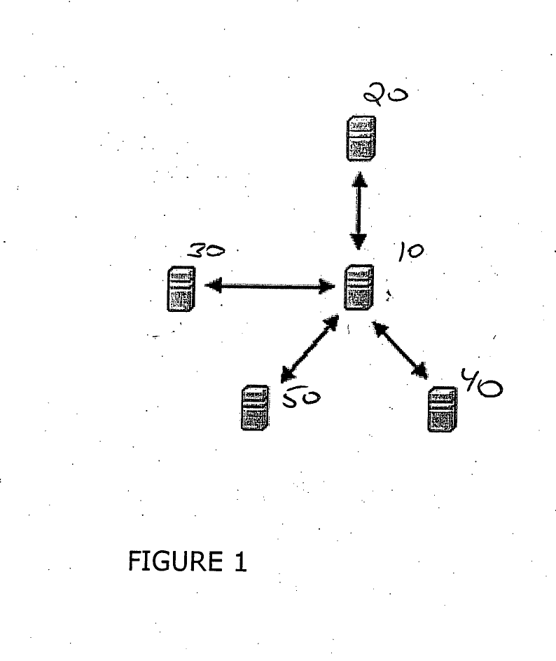

In a first embodiment of the present invention, as illustrated in FIG. 1, EIS may be employed on a server 10 to provide ERP (Enterprise Resource Planning) systems integration. EIS can function as the integration hub when a company needs to facilitate interaction between two or more ERP systems. For example, in the illustrated embodiment, a parent company could be running a mainframe 20, subsidiaries could be running SAP 30 (SYSTEMS APPLICATION PRODUCTS) and Oracle™ 40 applications, and a recently acquired company could be running the J. D. Edwards suite 50. EIS may be configured between them, as an integration hub, seamlessly controlling the flow of GL (General Ledger), AP (Accounts Payable) and AR (Accounts Receivable) data that often must be shared between these systems. As discussed in more detail below, EIS running on server 10 employs various logical modules to facilitate the integration.

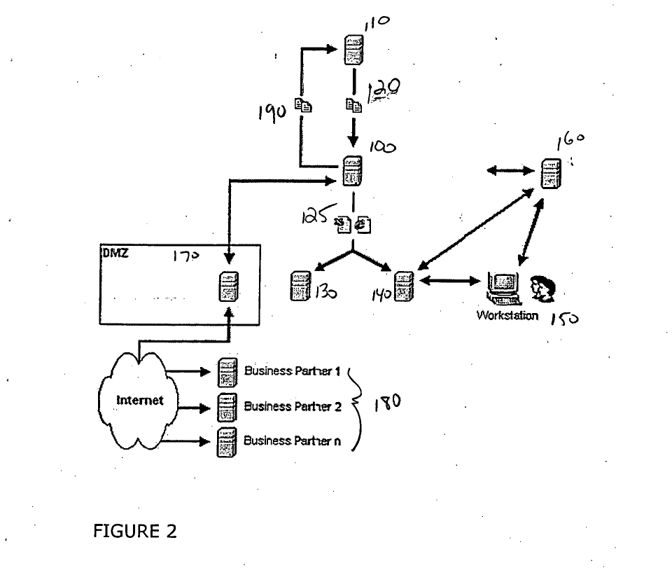

In a second embodiment of the present invention, as illustrated in FIG. 2, EIS may operate as an enterprise reporting application server 100. The system may generate static batch reports in many different formats including simple HTML as well as the feature-rich and extremely popular Excel™ format. It can also manage complex database population requirements for more dynamic web-based reporting systems. As illustrated, sever 100 running EIS of the present invention Enterprise applications on an SAP or Oracle mainframe 110 communicates files 120 periodically such as in nightly batch jobs.

Once receiving files 120 reports 125 are sent to a file server 130 and internet server 140 to be operated on by users at workstation 150. Information is also shared with data warehouse/reporting database 160. During integration, server 100 running EIS of the present invention is also in communication with public FTP web servers 170, that are connected to business partner serves 180. Once file integration is completed by server 100, as discussed in more detail below, completed files 190 are returned to client mainframe 110.

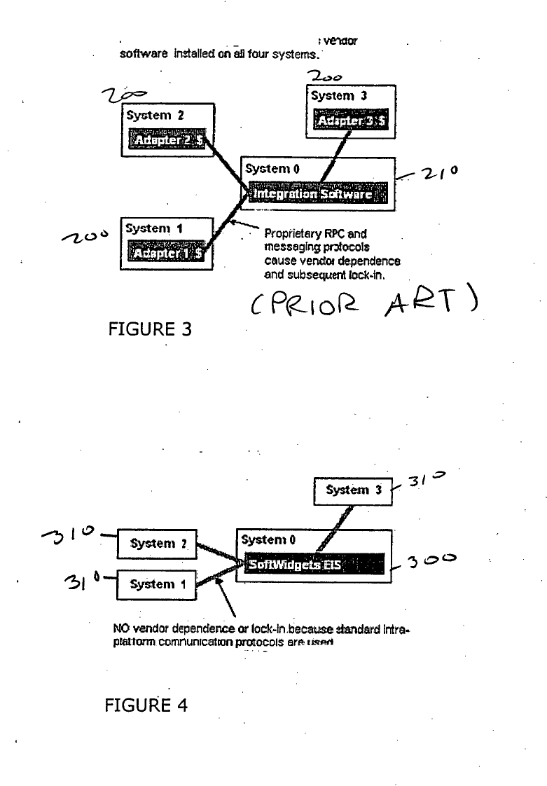

In a third embodiment of the present invention EIS may be used for database population or data transformation. EIS can handle the full automation of Oracle™, IBM DB2™ or Microsoft SQL Server™ database population/transformation task without any custom development. Many enterprises today are required to keep several database in sync for various reasons. For example, as illustrated in FIG. 3, a prior art integration system is shown that requires the integration system proprietary adapter software to be installed at all of the locations 200, as well as the integration system 210. The present invention as illustrated in FIG. 4, shows the EIS software of the present invention installed on only the integration system 300 itself, and not on any of the additional systems 310 with data being integrated.

In a fourth embodiment of the present invention, EIS may be used for e-mail automation. Many applications can benefit from the advanced e-mail automation capabilities that EIS can provide. A common example is the transformation of a manual business process into an email automated workflow.

In a fifth embodiment of the present invention, EIS may be used for file routing between platforms. There are many scenarios where moving files to and from a mainframe, a UNIX server and a Windows™ server is a requirement. As with many common middleware tasks, the EIS system of the present invention can do this via simple configurations, with no coding necessary.

Turning now to the integration modules that facilitate integration, FIG. 7 illustrates a block diagram of EIS system 400. In one embodiment of the present invention, EIS employs an anti rip-and-replace philosophy.

EIS system 400 of the present invention allows a user to take advantage of existing systems architectures. EIS system 400 is designed, from the ground up, to work well with all the major enterprise platforms.

EIS system 400 works in conjunction with intra-platform communication standards. The big three database providers (Oracle™, IBM™ and Microsoft™) all support standard ODBC (Open DataBase Connectivity), ensuring connectivity at a database level. Virtually all platforms support FTP, most support HTTP/HTTPS and SMTP, many support LDAP, and many in the future will support emerging Web Services standards such as SOAP (Simple Object Access Protocol). The protocols just mentioned cover all the basic aspects of integration, including database access, file and content transfer, email delivery, directory manipulation, messaging, and remote procedure calls. The focus on these common denominator communication standards is the reason why EIS system 400 works with and leverages the strengths of virtually any platform.

EIS system 400 operates in a noninvasive manner. The majority of EIS system 400 implementations only require a production installation of EIS software on a single computer. This is accomplished by relying on existing intra-platform communications standards, not proprietary adapter or wrapper APIs.

As noted above, many prior art integration packages require that you deploy their proprietary adapters or wrappers on various machines in the enterprise. This approach is inherently inflexible, disruptive to operations, often very risky to deploy and costly to maintain. It also allows the integration vendor to reinforce client dependence as pieces of their software spread throughout the enterprise. FIGS. 3 (prior art) and 4 illustrate the how EIS system 400 is different from other integration software providers.

EIS system 400 preferably includes a number of features such as being open to all/leverage existing staff. Programmatic extension of the suite is open to all developers with knowledge of virtually any programming language. This keeps staffing costs low by allowing an organization to leverage their existing developer base and avoid the lost productivity and costs associated with retraining.

EIS system 400 may be built with industry-standard software and runs on commodity hardware, making the infrastructure cost nearly 1/10 that of comparable systems on other platforms. EIS system 400 has mainframe-class stability. Because of a sophisticated process isolation engine, discussed in more detail below, that is at the core of EIS, when it is properly deployed, it boast “five nines” mainframe-class stability.

EIS system 400 is scalable. The unique architecture of EIS and the concurrency management capabilities result in scalability that is on par with systems costing millions of dollars. As a result of this scalability, significant savings can be realized through server consolidation. EIS system 400 maintains a building block design architecture. Like a building block kit, EIS includes several generic libraries and applications that can be re-used over an over again. Combined, these applications address the majority of common integration requirements. EIS system 400 is configured for easy operation. Operational support requirements are minimal because of the stability and the fully automated email-based error reporting. In fact, most clients with mission-critical deployments run the suite in “lights out” mode.

In one embodiment of the present invention, illustrated in FIG. 7, there are several elements to the EIS framework. In this section, the following key EIS applications are discussed
Radar
Monitor
Importer
Extractor
Uploader
UploaderD
Router
Mailer
RadarScript
SnapInHost
   EIS-Radar

Radar module 410 is the heart of the EIS system 400. It is a Windows service that functions as a sophisticated process manager, an enterprise file traffic cop, and the hub of the enterprise integration architecture. Radar 410 manages the execution of any process written in virtually any modern language (C/C++/C#, VB/VB.NET, Java, COBOL, Fortran, etc.). The Radar-EIS framework also consists of .NET and COM APIs that middleware developers can program against to make an application Radar-compliant leveraging all the extensive capabilities of Radar 410.

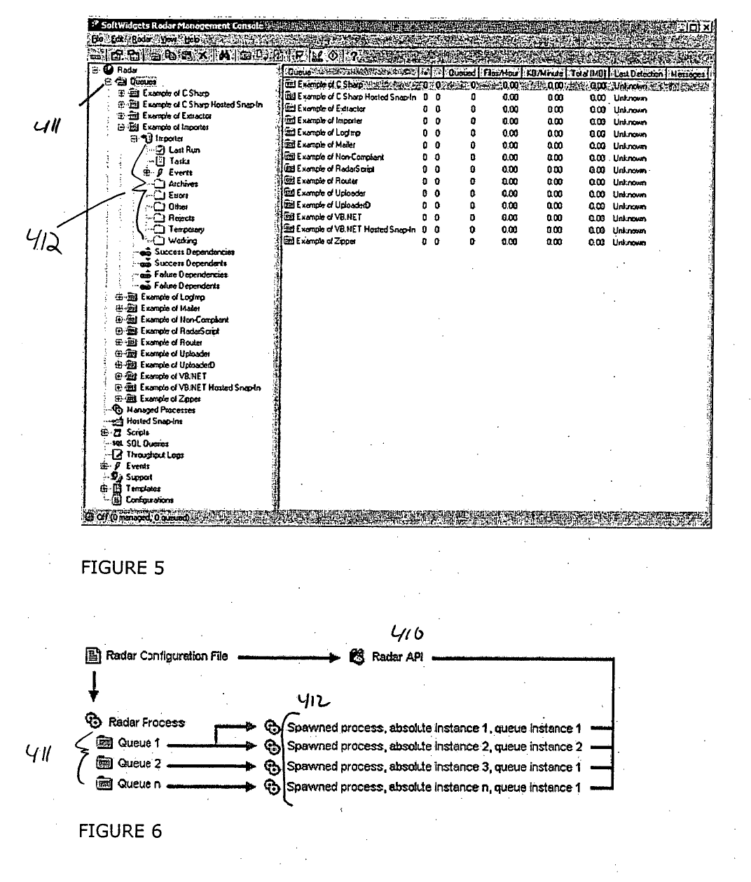

Radar module 410 is configured to watch for files to appear in queues and spawn associated processes. Queues are folders in your enterprise that are associated with a Radar-managed process. A good example is the common scenario where a file is extracted from a legacy system and FrPed to an integration server running Radar 410. See for example FIG. 2. When the extract file appears, Radar 410 detects it and spawns an instance of a managed process, such as Importer, that populates a database. FIG. 5 illustrates a screen shot of the Radar UI that illustrates the relationship between a file queue 411 and an associated managed process 412.

Radar 410 may further be configured to control process concurrency. Radar 410 controls process concurrency, both in a particular queue and across any number of queues. For example, if ten files are queued up simultaneously in one queue, Radar 410 can be set to only run three processes concurrently. In this scenario, as soon as one process finishes, the next file in the queue gets processed and the window slides up one until all ten processes are complete. This is extremely important for stability and scalability. Middleware infrastructures without this sort of process control are very vulnerable to process overload and subsequent server failure simply because there is no control over how many processes are running concurrently.

Radar 410 may also be configured to chain processes. Radar 410 allows an administrator to chain any number of process together based on job success or failure. Chaining addresses the flexibility requirements of separate but dependent process.

Radar 410 may also maintain a standard folder structure. One of the more important features of Radar 410 is its ability to define and maintain a folder structure that segregates incoming files based on process and process instance.

Radar 410 may further be configured to route files. Incoming files, upon process termination, can be routed to standard archive and error folders depending on process success or failure. They can also be routed to other queues for further processing.

Radar 410 may further be configured to perform auto queuing. Any queue can be configured to automatically execute jobs based on a schedule. Radar 410 can perform task, event and error logging. As part of the API, developers can leverage the powerful logging capabilities. Radar 410 can also handle data throughput metering. Radar 410 provides a real-time view and full metering of file traffic. Metrics may include but are not limited to Files/Hour, KB/Minute and Total MB. This feature is especially useful for business models where revenue is a function of the amount of data processed.

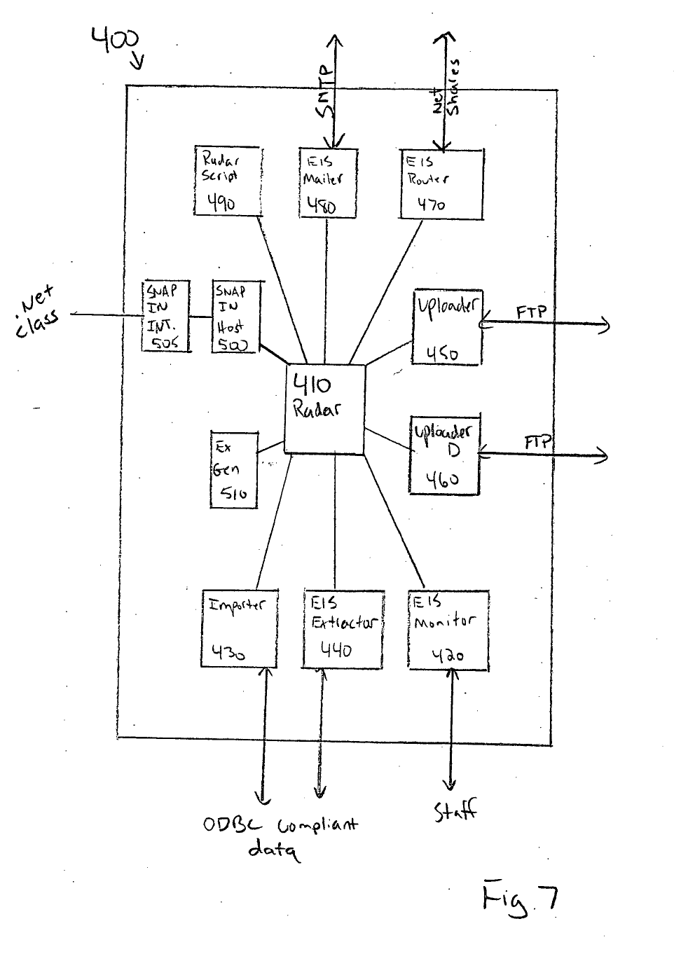

With Radar 410 in place and configured properly, thousands of individual queues can be managed and the associated processes with the piece of mind that they are all under control. FIG. 6 illustrates an abstract diagram illustrating Radar 410, the queues 411 and processes 412 that it manages and their relationship to the EIS.

The Radar 410 configuration file governs the operation of both Radar 410 and any Radar-managed process built with the Radar library. Contained in this file, is all the information for each queue that Radar 410 manages. Any process that uses the Radar library, therefore has access to Radar's configuration. This, along with the command line conduits (horizontal arrows in FIG. 6) is how communication is achieved between Radar 410 and any process that is managed by Radar 410.

This system 400 design is extremely robust because there is no run-time binding between the process manager and any of the managed processes and because it provides complete process isolation. In-other-words, if a managed process fails, the process manager in this architecture does not fail. This is in stark contrast to the more common, tightly-coupled hosted architectures that require run-time bindings via rigid interfaces.

Radar 410 manages multiple instances of a process at the queue level and across queues. FIG. 6 illustrates how Radar 410 can have four instances of a process 412 running concurrently across three separate queues 411.

EIS Monitor

EIS Monitor 420 is a Windows service that is designed to track and display events reported by unattended server-based processes. Essentially, it allows an operations and development staff to scan for log files that have been written to any folder on just about any kind of server. Preferably the EIS monitor 420 provides features including but not limited to:

1) Real time event monitoring for any number of applications on any number of servers through one UI.

2) Distinction/choice of three severity levels for a given event (Information, Warning, Critical).

3) Ability to mitigate severity levels within an operational or “big picture” context. In-other-words, an event may be critical at a process level, but may only be a warning within the greater operational context of the enterprise.

4) The ability to monitor via LAN/WAN scanning and HTTP-based scanning concurrently. HTTP scanning allows remote monitoring of any web server that supports scripting. This feature is particularly useful when scanning a server that is sitting behind a firewall in a DMZ(Demilitarized Zone).

5) SMTP(Simple Mail Transfer Protocol) email integration. Any event can be configured to trigger an email message.

6) Robust, full featured configuration editor.

7) Integrated event log viewer.

8) One-button event log archive management.

9) Ability to associate each event with a URL that can contain web-based reference manual for the monitored process. This feature makes troubleshooting considerably easier for non developers.

10) Complete per-process log file isolation, ensuring bullet proof performance.

Essentially, developers and operations staff use EIS Monitor 420 to view, alert and manage all custom enterprise logging. EIS Monitor 420 works nicely with the functionality provided by the standard Windows event viewer, but allows for more control and flexibility. The staff have direct access to Monitor 420 via a separate management console.

EIS Importer

EIS Importer 430 is a generic Radar-managed process that imports data into any ODBC-compliant data store. Importer 430 is an application that encapsulates the majority of common middleware tasks associated with flat file database updates. Preferably, EIS importer 430 handles certain functions including but not limited to:

1) Connecting to databases and obtaining insertion-optimized data sets.

2) Transaction management at a process and file level. In-other-words, n number of files are imported, all within one transaction or each individual file may be imported as a separate and distinct transaction.

3) Post process stored procedure execution. This allows for the spawning of additional processing on the destination platform.

4) Pre and post importation stored procedure execution at an individual file level. This is especially handy for when an index drop is desired prior to file importation and a re-indexing of the destination table is desired after importation.

5) Custom transformation of data via simple and fully documented Java or Visual Basic transformation script interfaces.

6) Verbose event, error and task logging.

7) Post process file routing and archiving.

8) Advanced thread management and process throttling.

9) Diagnostics, including record count tie-outs.

Importer handles simple fixed and delimited importation via a few configuration settings (i.e. no coding is necessary). If custom there are data transformations or scrubbing requirements, then custom Java or Visual Basic transformation scripts can easily be written to accommodate those needs.

When configured properly, EIS Importer 430 scales to load anything from single-record files to 1,000,000,000+ record files with carrier-grade speed, accuracy and reliability.

EIS Extractor

EIS Extractor 440 is a Radar-managed process that allows for the extraction of data from any ODBC-compliant data source illustrates an abstract diagram illustrating Radar, the queues and processes that it manages and their relationship to the EIS via an ODBC interface. Extractor 440 generates preferably any flat file format that is needed with no coding required. Also, it supports rich, high performance Java and Visual Basic data transformation capabilities via a simple, standard and fully documented transformation script interface. It is used for heterogeneous database environments for maintaining extraction logic in the middleware tier instead of the database tier. Another key advantage Extractor 440 has over native extraction tools that ship with most database servers is its tight integration with the rest of the EIS 400 framework.

EIS Uploader

EIS Uploader 450 is a Radar-compliant application that uploads files via FTP. FTP is one of the oldest computer communications protocols and it is widely supported by almost all platforms, thus making Uploader 450 a key element of systems integration. EIS Uploader 450 makes any integration task that requires FTP file transmissions easy and robust by preferably providing the following advanced enterprise-class functionalities which include but are not limited to:

1) Support for FTP to virtually any platform (e.g. Mainframe, Windows, UNIX and Linux).

2) Guaranteed delivery via retry capability.

3) File name translation capability.

4) Ability to remotely execute or startup jobs via trigger file or stored procedure after uploads are complete.

5) Ability to compress and encrypt files prior to upload.

6) Multiple upload modes to accommodate many different transmission requirements including single, group, recursive and recursive proxy.

These features outlined above, when configured properly, provide bullet-proof FTP file transfers.

EIS UploaderD

EIS UploaderD 460 is a Radar-compliant application that distributes files via FTP to multiple destinations (“D” in the UploaderD name). Among other uses, this application is ideal for distributing copies of files to a farm of web servers. At an individual destination level, UploaderD 460 is very similar to the Uploader 450 application. The basic difference between the two applications is the fact that UploaderD 460 can upload files to multiple destinations.

EIS Router

EIS Router 470 is yet another application designed to move files around a network. It is different than Uploader 450, however, because it does not transfer files via FTP. It sends files through network shares. In general, Router 470 requires less configuration and network support than Uploader 450, and is preferably used between LDAP-compliant or Active Directory compliant platforms.

Some EIS Router 470 features may include but are not limited to:

1) Full featured, graphical configuration editor.

2) Retry capability to ensure guaranteed delivery.

3) Dynamic, authenticated drive mapping capability. This is important because persistent drive mappings are not considered a best practice in server-side environments. It also allows for the case when a mapping is unavoidable because a UNC-style share reference cannot be utilized due to authentication requirements of a destination platform.

A typical Router deployment scenario would be a Windows-to-Novell and/or Windows-to-Windows intra-domain file transfer to distribute batch-generated reports to file servers.

EIS Mailer

EIS Mailer 480 is a Radar-compliant application that is designed to automate email delivery via standard SMTP. Mailer is powerful because it can be used in numerous notification and alert scenarios to streamline many business processes. Some features that make EIS mailer 480 an integration architecture building block can include but are not limited to:

1) Simple design that leverages existing technology. To send out emails, Mailer interfaces with the standard Windows SMTP service via CDO. This design avoids reinventing the wheel and takes advantage of a proven, rock-solid SMTP mailing service.

2) Guaranteed delivery.

3) Ability to send file attachments.

4) Extensibility and dynamic mailing capability via a simple scripting interface.

The features outlined above, when configured properly, provide bullet-proof email delivery for any integration project. Many systems can benefit from email automation. Mailer makes it all possible without any development effort.

EIS RadarScript

RadarScript 490 is a Radar-managed application that hosts and automates the execution of any Java or Visual Basic script. Radar 410 preferably does not allow direct execution of scripts. The task of script execution is delegated to isolated, discrete and fully error-trapped instances of RadarScript 490 that can be associated with Radar queues 411. This design insures bulletproof run-time stability and performance.

RadarScript 490 is an ideal choice for server-side automation in three key scenarios:

1) When the requirements are simple and, hence, do not warrant the implementation of a full-fledged stand-alone executable.

2) When hosting the execution of business logic that is encapsulated in a C++, VB or Java class library.

3) When the code is potentially buggy.

The latter two scenarios are typical in an enterprise when an IT staff is overworked or not qualified to write robust Radar-compliant stand-alone applications. By directing the IT staff to write scripts or components that focus only on the business logic, no matter what errors they may have forgot to trap, RadarScript 490 ultimately catches them and does not allow run-time errors and the subsequent hung or “dead” process that is the hallmark of untrapped errors.

EIS SnapInHost

EIS SnapInHost 500 is a Radar-managed application that hosts any .NET class that implements the Radar SnapIn interface 505. The procedure for creating a snap-in is outlined, complete with sample code, in the Radar library documentation that is included with EIS. SnapInHost 500 is similar to RadarScript 490 in that it is an application designed to host code execution, only it is much more powerful because it allows code to be written using all the features of Visual Studio.NET and the .NET Framework.

SnapInHost 500 is an ideal choice for server-side automation in four key scenarios:

1) When an organization uses Visual Studio.NET.

2) When the requirements do not warrant the implementation of a full-fledged stand-alone NET executable.

3) When hosting the execution of business logic that is encapsulated in a C#, VB.NET or a Java class library.

4) When executing potentially buggy code hosted and fully error trapped to ensure exceptional run-time stability.

SnapInHost 500 allows for the same benifits as RadarScript 490 when EIS system 400 is deployed in scenarios where the IT staff is overworked or not qualified to write robust Radar-compliant stand-alone applications. By directing the staff to write .NET snap-in components, no matter what errors they may have forgot to trap, SnapInHost 500 ultimately catches them.

ExGen and EIS Extensibility

ExGen 510 is a Radar-compliant Excel reporting add-on to EIS that underscores the inherent extensibility of the EIS platform 400. Used in conjunction with EIS, ExGen 510 may be the foundation of a custom-tailored enterprise reporting system and/or business intelligence solution. Below are key ExGen 510 features which include but are not limited to:

1) ExGen 510 automatically generates spreadsheets from almost any data source (Oracle, DB2, SQL Server, Sybase, Access, and more) via simple SQL statements.

2) ExGen 510 automatically routes generated spreadsheets to multiple email address and/or to network file servers.

3) ExGen 510 populates predefined templates that have look-and-feel elements designed by business users of the spreadsheet instead of the IT staff.

4) In a single run, ExGen 510 generates multiple workbooks.

5) For each workbook generated by ExGen 510, multiple worksheets are populated with data.

6) The features cited above require no custom coding. ExGen 510 includes a very intuitive configuration interface that allows an IT professional to meet the majority of common automated spreadsheet generation and delivery requirements with no coding.

7) In cases where the spreadsheet generation requirements are beyond the out-of-the-box capabilities of ExGen 510, extensibility is provided for via a set of fully documented .NET 1.1 compliant snap-in interfaces.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for performing system integrations between at least first and second systems, said method comprising the steps of:
operating an integration operation on only a third system with no adapters installed on said first and second systems, said integration operation including:
generating a plurality of integration processes, each said process configured to perform one or more integration functions, integrating an element of a first system with an element of a second system;
organizing said integration processes into a queue, with at least one queue assigned to said integration processes; and
isolating each integration process from one another, such that failure of a first integration process among said plurality of integration processes does not result in the failure of any other integration process.

2. The method as claimed in claim 1, wherein two or more of said integration processes may be run concurrently.

3. The method as claimed in claim 1, wherein two or more of said integration processes may be connected to run as a single chain process.

4. The method as claimed in claim 1, wherein upon completion of one of said integration processes, a result may be routed to standard archive, error folders or to other queues for further processing, depending on process success or failure.

5. The method as claimed in claim 1, wherein said organizing said integration processes into a queue is performed automatically according to a schedule.

6. A method for performing system integrations between at least first second and third systems, said method comprising the steps of:
operating an integration operation on only a fourth system with no adapters installed on said first, second and third systems, said integration operation including:
generating a plurality of integration processes, each said process configured to perform one or more integration functions, integrating an element from any one of said first, second and third systems with an element of a another system among said first, second and third systems;
organizing said integration processes into a queue, with at least one queue assigned to said integration processes; and
isolating each integration process from one another, such that failure of a first integration process among said plurality of integration processes does not result in the failure of any other integration process.

7. The method as claimed in claim 6, wherein two or more of said integration processes may be run concurrently.

8. The method as claimed in claim 6, wherein two or more of said integration processes may be connected to run as a single chain process.

9. The method as claimed in claim 6, wherein upon completion of one of said integration processes, a result may be routed to standard archive, error folders or to other queues for further processing, depending on process success or failure.

10. The method as claimed in claim 6, wherein said organizing said integration processes into a queue is performed automatically according to a schedule.

11. A system for performing integrations between at least first and second systems, said system comprising:
a management module for performing an integration operation on a third system with no adapters installed on said first and second systems, said integration operation including:
generating a plurality of integration processes, each said process configured to perform one or more integration functions, integrating an element of the first system with an element of the second system;
organizing said integration processes into a queue, with at least one queue assigned to said integration processes; and
and isolating each integration process from one another, such that failure of a first integration process among said plurality of integration processes does not result in the failure of any other integration process.

12. The system as claimed in claim 11, wherein two or more of said integration processes may be run concurrently.

13. The system as claimed in claim 11, wherein two or more of said integration processes may be connected to run as a single chain process.

14. The system as claimed in claim 11, wherein upon completion of one of said integration processes, a result may be routed to standard archive, error folders or to other queues for further processing, depending on process success or failure.

15. The system as claimed in claim 11, wherein said organizing said integration processes into a queue is performed automatically according to a schedule.

16. The system as claimed in claim 11, further comprising a monitor module, coupled to said management module configured to track and display events reported by unattended server-based integration processes.

17. The system as claimed in claim 11, further comprising an importer coupled to said management module configured to import data to said system.

18. The system as claimed in claim 11, further comprising an extractor coupled to said management module configured to extract data to said system from compliant sources.

19. The system as claimed in claim 11, further comprising an uploader configured to upload files to said system from an FTP (File Transfer Protocol).

20. A system for performing integrations between at least first second and third systems, said system comprising:
a management module for performing an integration operation on a fourth system with no adapters installed on said first, second and third systems, said integration operation including:
generating a plurality of integration processes, each said process configured to perform one or more integration functions, integrating an element from any one of said first, second and third systems with an element of a another system among said first, second and third systems;
organizing said integration processes into a queue, with at least one queue assigned to said integration processes; and
and isolating each integration process from one another, such that failure of a first integration process among said plurality of integration processes does not result in the failure of any other integration process.
